(19) United States
(12) Patent Application Publication
(10) Pub. No.: US 2026/0003205 A1
(43) Pub. Date: Jan. 1, 2026

(54) LENS ARRAY, DISPLAY DEVICE INCLUDING THE SAME, AND ELECTRONIC DEVICE INCLUDING THE SAME

(71) Applicant: SAMSUNG DISPLAY CO., LTD., YONGIN-SI (KR)

(72) Inventors: Yu Kyung LEE, Yongin-si (KR); Jin Ho JU, Yongin-si (KR)

(21) Appl. No.: 19/240,797

(22) Filed: Jun. 17, 2025

(30) Foreign Application Priority Data
Jun. 26, 2024 (KR) 10-2024-0083925
Sep. 9, 2024 (KR) 10-2024-0122342

(51) Int. Cl. G02B 30/50; G02F 1/1335

(52) U.S. Cl. CPC G02B 30/50; G02F 1/133526; G02F 1/133531

(57) ABSTRACT

A lens array includes a polarizing layer polarizing light traveling in the lens array. A first electrode layer is disposed on the polarizing layer. A lens layer is disposed on the first electrode layer. A second electrode layer is disposed on the lens layer and faces the first electrode layer.

### CROSS-REFERENCE TO RELATED APPLICATIONS

This application claims priority under 35 U.S.C. § 119 to Korean Patent Application No. 10-2024-0083925, filed on Jun. 26, 2024 in the Korean Intellectual Property Office (KIPO), and Korean Patent Application No. 10-2024-0122342, filed on Sep. 9, 2024 in KIPO, the disclosures of which are incorporated by reference in its entirety herein.

### 1. TECHNICAL FIELD

The present disclosure generally relates to a lens array, a display device including the same, and an electronic device including the same.

### 2. DISCUSSION OF RELATED ART

A stereoscopic image display device is a display device which provides a physical factor so that a viewer three-dimensionally recognizes a real object by stimulating a visual sense of the viewer to be identical or similar to the real object. For example, the stereoscopic image display device provides different images to the left and right eyes of the viewer so that the viewer can view a stereoscopic image due to a binocular parallax between the left and right eyes.

Recently, research for a glasses-free type of three-dimensional imaging in which a viewer does not wear stereoscopic glasses has been actively conducted. The glasses-free type may include a lenticular type in which a left eye image and a right eye image are separated from each other by using a cylindrical lens array, a barrier type in which a left eye image and a right eye image are separated from each other by using a barrier, and the like.

### SUMMARY

Embodiments of the present disclosure provide a lens array including a polarizing layer.

Embodiments of the present disclosure also provide a display device including a lens array.

Embodiments of the present disclosure also provide an electronic device including a lens array.

Embodiments of the present disclosure also provide a display device including a polarization conversion unit including a polarizing layer.

According to an embodiment of the present disclosure, a lens array includes a polarizing layer polarizing light traveling in the lens array. A first electrode layer is disposed on the polarizing layer. A lens layer is disposed on the first electrode layer. A second electrode layer is disposed on the lens layer and faces the first electrode layer.

In an embodiment, the polarizing layer may be formed through an imprinting process.

In an embodiment, the polarizing layer may be a wire grid polarizer.

In an embodiment, the polarizing layer may include an optical pattern and a passivation layer covering the optical pattern.

In an embodiment, the optical pattern may include a metal.

In an embodiment, the optical pattern may have a stripe shape.

In an embodiment, the lens array may further include a liquid crystal layer disposed between the first electrode layer and the lens layer.

In an embodiment, the lens layer may include an optically isotropic polymer.

In an embodiment, the polarizing layer may polarize the light in a polarization direction. When an electric field is formed between the first electrode layer and the second electrode layer, a refractive index of the lens layer may be higher than a refractive index of the liquid crystal layer with respect to the polarization direction.

In an embodiment, the polarizing layer may polarize the light in a polarization direction. When there is no electric field formed between the first electrode layer and the second electrode layer, a refractive index of the lens layer may be substantially equal to a refractive index of the lens layer with respect to the polarization direction.

In an embodiment, the lens array may further include a first substrate. The polarizing layer may be disposed above the first substrate.

In an embodiment, the lens array may further include a first substrate. The polarizing layer may be disposed under the first substrate. The first electrode layer may be disposed above the first substrate.

In an embodiment, the lens array may further include a first substrate and a second substrate. The lens layer may be disposed between the first substrate and the second substrate.

According to an embodiment of the present disclosure, display device includes a display panel including a pixel. A lens array is disposed on the display panel. The lens array includes a polarizing layer polarizing light incident from the display panel. A lens layer is disposed on the polarizing layer. The display panel does not include the polarizing layer.

In an embodiment, the lens array may be attached to the display panel through an adhesive material.

In an embodiment, the lens array may further include a first substrate. The polarizing layer may be disposed on the first substrate. The adhesive material may be in direct contact with the first substrate.

In an embodiment, the lens array may further include a first substrate. The polarizing layer may be disposed under the first substrate. The adhesive material may be in direct contact with the polarizing layer.

In an embodiment, the lens array may further include a first electrode layer disposed on the polarizing layer. A liquid crystal layer is disposed on the first electrode layer. A second electrode layer is disposed on the liquid crystal layer. In a first mode, there is no driving voltage supplied to either of the first electrode layer and the second electrode layer. In a second mode, a driving voltage may be supplied to any one of the first electrode layer and the second electrode layer.

In an embodiment, the polarizing layer may polarize the light in a polarization direction. In the second mode, light incident onto the lens layer may be refracted in the polarization direction.

In an embodiment, the polarizing layer may polarize the light in a polarization direction. In the first mode, light incident onto the lens layer may progress straight.

According to an embodiment of the present disclosure, a display device includes a display panel including a pixel. The display panel does not include a polarizing layer. A polarization conversion unit is disposed on the display panel. A lens array is disposed on the polarization conversion unit. The polarization conversion unit include: a polarizing layer polarizing light incident from the display panel in a polarization direction. A liquid crystal layer is disposed on the polarizing layer.

According to an embodiment of the present disclosure, an electronic device includes a processor providing an input image data. The display panel includes pixels for displaying an image corresponding to the input image data. A lens array is disposed on the display panel. The lens array includes a polarizing layer polarizing light incident from the display panel. A lens layer is disposed on the polarizing layer.

### BRIEF DESCRIPTION OF THE DRAWINGS

Example non-limiting embodiments will now be described more fully hereinafter with reference to the accompanying drawings; however, the present disclosure may be embodied in different forms and should not be construed as limited to the described embodiments set forth herein.

FIG. 1 is a view illustrating a lens array type display device according to an embodiment of the present disclosure.

FIG. 2 is a view schematically illustrating a display device in accordance with an embodiment of the present disclosure.

FIG. 3 is a cross-sectional view illustrating a display device shown in FIG. 2 according to an embodiment of the present disclosure.

FIG. 4 is a cross-sectional view illustrating a display device shown in FIG. 2 according to an embodiment of the present disclosure.

FIG. 5 is a cross-sectional view illustrating an example in which the display device shown in FIG. 3 operates in a first mode according to an embodiment of the present disclosure.

FIG. 6 is a cross-sectional view illustrating an example in which the display device shown in FIG. 3 operates in a second mode according to an embodiment of the present disclosure.

FIGS. 7 to 13 are views illustrating an example in which a polarizing layer shown in FIG. 3 is formed according to embodiments of the present disclosure.

FIG. 14 is a view illustrating an arrangement of optical patterns shown in FIG. 13 according to an embodiment of the present disclosure.

FIG. 15 is a cross-sectional view illustrating a display device in accordance with an embodiment of the present disclosure.

FIG. 16 is a cross-sectional view illustrating a display device in accordance with an embodiment of the present disclosure.

FIG. 17 is a schematic block diagram illustrating an electronic device including a display device in accordance with an embodiment of the present disclosure.

FIG. 18 is a schematic diagram illustrating an example where the electronic device of FIG. 17 is a smartphone according to an embodiment of the present disclosure.

FIG. 19 is a schematic diagram illustrating an example where the electronic device of FIG. 17 is a tablet computer according to an embodiment of the present disclosure.

### DETAILED DESCRIPTION OF EMBODIMENTS

Hereinafter, embodiments of the present disclosure will be described in more detail with reference to the accompanying drawings. In the description below, only a necessary part to understand an operation according to an embodiment of the present disclosure is described and the descriptions of other parts may be omitted in order not to unnecessarily obscure subject matters of embodiments of the present disclosure. In addition, the present disclosure is not limited to embodiments described herein, but may be embodied in various different forms.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

In the entire specification, when an element is referred to as being “connected” or “coupled” to another element, it can be directly connected or coupled to the another element or be indirectly connected or coupled to the another element with one or more intervening elements interposed therebetween. The technical terms used herein are used only for the purpose of illustrating a specific embodiment and not intended to limit the embodiment. It will be understood that when a component “includes” an element, unless there is another opposite description thereto, it should be understood that the component does not exclude another element but may further include another element. It will be understood that for the purposes of the present disclosure, “at least one of X, Y, and Z” can be construed as X only, Y only, Z only, or any combination of two or more items X, Y, and Z (e.g., XYZ, XYY, YZ, ZZ). Similarly, for the purposes of the present disclosure, “at least one selected from the group consisting of X, Y, and Z” can be construed as X only, Y only, Z only, or any combination of two or more items X, Y, and Z (e.g., XYZ, XYY, YZ, ZZ).

It will be understood that, although the terms “first”, “second,” etc. may be used herein to describe various elements, these elements should not be limited by these terms. These terms are only used to distinguish one element from another element. Thus, a “first” element discussed below could also be termed a “second” element without departing from the teachings of the present disclosure.

Spatially relative terms, such as “below,” “above,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the term, “above,” may encompass both an orientation of above and below. The apparatus may be otherwise oriented (e.g., rotated 90 degrees or at other orientations) and the spatially relative descriptors used herein interpreted accordingly.

In addition, embodiments of the present disclosure are described here with reference to schematic diagrams of ideal embodiments (and an intermediate structure) of the present disclosure, so that changes in a shape as shown due to, for example, manufacturing technology and/or a tolerance may be expected. Therefore, embodiments of the present disclosure shall not necessarily be limited to the specific shapes of a region shown here, but include shape deviations caused by, for example, the manufacturing technology. The regions shown in the drawings are schematic in nature, and the shapes thereof may not represent the actual shapes of the regions of the device, and do not necessarily limit the scope of embodiments of the present disclosure.

Hereinafter, non-limiting embodiments of the present disclosure will be described in detail with reference to the accompanying drawings.

The present disclosure relates to a stereoscopic (3D) display device in which a lens array overlaps a display panel and includes a polarizing layer and a liquid crystal layer. The display panel does not include a polarizing layer. When an electrical potential is formed between a first electrode and a second electrode of the lens array, the refractive index of the lens is higher than a refractive index of the liquid crystal layer. Thus, light emitted from a pixel and passing through the liquid crystal layer may be refracted by the lens to be divided into a progress path of light corresponding to a right-eye image and a progress path of light corresponding to a left-eye image so that the user may perceive a 3D effect. Since the lens array includes the polarizing layer and the display panel does not separately include a polarizing layer, an error between the direction which light is polarized by the polarizing layer and the direction in which the liquid crystal molecules are aligned is considerably reduced so that image quality characteristics of the stereoscopic images are increased.

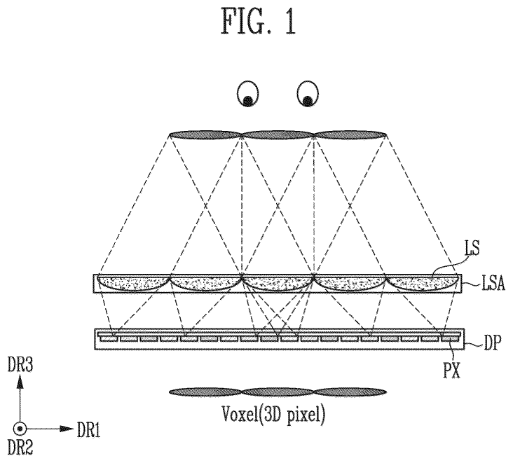

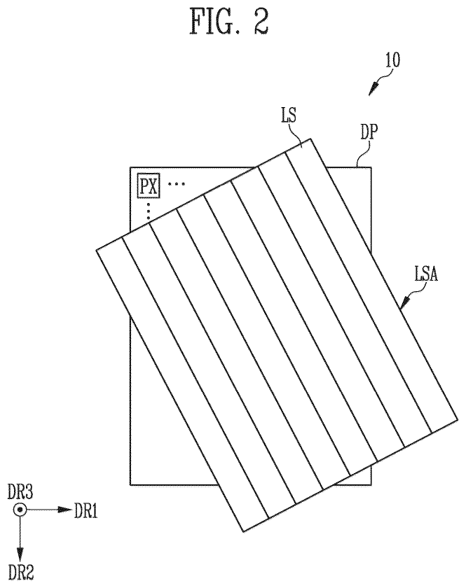

FIG. 1 is a view illustrating a lens array type display device. FIG. 2 is a view schematically illustrating a display device 10 in accordance with embodiments of the present disclosure.

Referring to FIGS. 1 and 2, the display device 10 may include a display panel DP and a lens array LSA. For example, in an embodiment the display device 10 may be a stereoscopic image display device which displays a stereoscopic image (3D image). The display panel DP and the lens array LSA may be arranged to overlap with each other in a vertical direction (e.g., a third direction DR3).

The display panel DP may include pixels PX which emit light, thereby displaying an image. In an embodiment, each of the pixels PX may output one of red light, green light, and blue light. However, this is merely illustrative, and the color of light emitted from the pixel PX is not necessarily limited thereto. Lights of one or various colors for full-color implementation may be output.

In an embodiment, the display panel DP may be connected to a driving circuit which drives the pixels PX. In an embodiment, the driving circuit may perform functions of at least one of a gate driver, a data driver, and a driving controller. For example, the driving circuit may be connected to the display panel DP and may be arranged at a rear surface of the display panel DP. For example, at least a portion of the driving circuit may be formed directly in the display panel DP or be disposed at a rear surface of the display panel DP.

In an embodiment, the pixels PX may be disposed at the front surface of the display panel DP to form an emission surface. An image may be displayed through the pixels PX. In an embodiment, the pixels PX may constitute a plurality of pixel rows and a plurality of pixel columns. In an embodiment, each of the pixel rows may mean a group of pixels connected to the same gate line, and each of the pixel columns may mean a group of pixels connected to the same data line. For example, the pixel rows may be arranged in a first direction DR1, and the pixel columns may be arranged in a second direction DR2 intersecting the first direction DR1. For example, in an embodiment the first and second directions DR1, DR2 may be perpendicular to each other. However, embodiments of the present disclosure are not necessarily limited thereto.

In an embodiment, the display panel DP may include a pixel circuit layer and a display element layer, which are disposed on a predetermined substrate to form the pixels PX. The display panel DP may further include an encapsulation structure which encapsulates the display element layer. In an embodiment, the display panel DP may further include a polarizing layer. The polarizing layer may include a phase retarder and/or a polarizer. In an embodiment, the polarizing layer may be located on the encapsulation structure. However, embodiments of the present disclosure are not necessarily limited thereto. For example, the polarizing layer may be located outside the display panel DP in some embodiments as will be described herein.

The pixel circuit layer may include a pixel circuit configured to drive a light emitting element of each pixel PX. For example, the pixel circuit layer may include transistors, and signal lines and power lines, which are connected to the transistors. The pixel circuit layer may have a stacked structure for forming the transistors.

The display element layer may be disposed on the pixel circuit layer. The display element layer may include light emitting elements. The light emitting elements may be electrically connected to the pixel circuits of the pixel circuit layer. In an embodiment, the light emitting element may be a self-luminous element. For example, in an embodiment the self-luminous element may include an organic light emitting element, an inorganic light emitting element, or a light emitting element configured with a combination of inorganic and organic materials. In the above embodiment, the display panel DP may be a self-luminous display panel. However, embodiments of the present disclosure are not necessarily limited thereto. For example, in an embodiment, the light emitting element may include a light emitting element (e.g., a quantum dot display element) which emits light by changing a wavelength of light emitted using a quantum dot.

Also, in some embodiments the display panel DP may be implemented as a liquid crystal display panel, a plasma display panel, a display panel which displays an image, using a quantum dot, or the like.

The lens array LSA may be disposed on the display panel DP, and includes lenses LS which refract light incident from the pixels PX. For example, in an embodiment the lens array LSA may be implemented as a lenticular lens array, a micro lens array, or the like.

A light field display is a three-dimensional (3D) display which implements a stereoscopic image by forming a light field expressed with a vector distribution (e.g., intensity and direction) of light in a space, using a flat panel display and an optical element (e.g., the lens array LSA). The light field display refers to a display technique in which a depth, a side, and the like of an object can be viewed, so that a more natural stereoscopic image can be implemented, thereby expecting various uses through fusion with a Virtual Reality (VR) technique, an Augmented Reality (AR) technique, a Mixed Reality (MR) technique, an extended Reality (XR) technique, and the like.

The light field may be implemented using various methods. For example, in an embodiment the light field may be formed using a method of making light fields in several directions, using several projectors, a method of controlling a direction of light, using a grating, a method of controlling a direction and an intensity (e.g., luminance) of light according to a combination of pixels, using two or more panels, a method of controlling a direction of light, using a pinhole or a barrier, a method of controlling a refraction direction of light through a lens array, or the like.

In an embodiment, as shown in FIG. 1, the lens array type display device 10 using a lens array method may form a light field, thereby displaying a stereoscopic image (e.g., a 3D image).

In an embodiment, a series of pixels PX may be allocated to each lens LS, and light emitted from each pixel PX may be refracted by the lens LS to progress in only a specific direction, thereby forming a light field expressed with an intensity and a direction of the light. When a viewer views the display device 10 in the light field formed as described above, the viewer can perceive a 3D effect of a corresponding image.

Image information according to a viewpoint of the viewer within the light field may be defined and processed in units of voxels. The voxel may be understood as graphic information which defines a predetermined point (e.g., a pixel) in a 3D space.

In an embodiment, the lens array LSA may include a semicylindrical lens LS extending in one direction. The lens LS may be implemented as, for example, a lenticular lens. For example, as shown in FIG. 2, in an embodiment the lenses LS may be obliquely disposed with respect to each of the first direction DR1 and the second direction DR2 to extend (e.g., referred to as a slanted arrangement). However, this is merely illustrative, and the extension direction (e.g., an arrangement direction) of the lens LS is not necessarily limited thereto.

In an embodiment, a size and an arrangement of the lens LS may be determined by conditions such as a size of the display panel DP, a viewing distance of the viewer, a size of the pixel PX, a resolution, and a pixel arrangement structure.

In an embodiment, the lens LS may be implemented as a micro lens. When viewed on a plane, the micro lens may have a shape such as a hexagonal shape, a circular shape, or an elliptical shape.

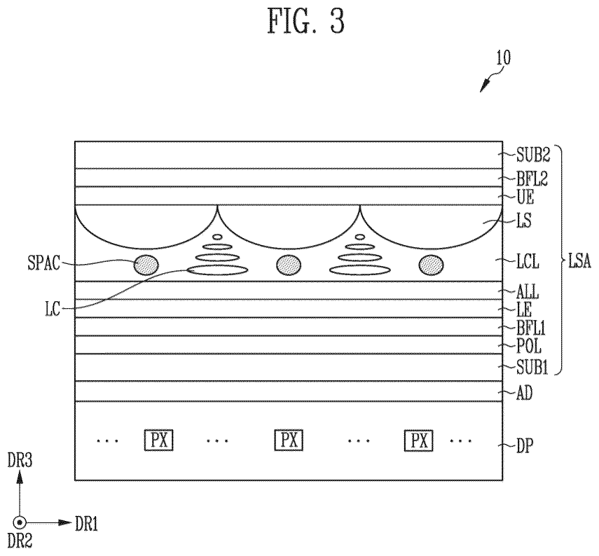

FIG. 3 is a cross-sectional view illustrating an embodiment of the display device 10 shown in FIG. 2.

Referring to FIG. 3, the display device 10 may include a display panel DP and a lens array LSA.

The lens array LSA may be disposed on the display panel DP (e.g., in a third direction DR3). In an embodiment, the lens array LSA may be attached to (e.g., secured thereto) the display panel DP through a transparent adhesive material AD. In an embodiment, the transparent adhesive material AD may include an Optically Clear Adhesive (OCA) or an Optically Clear Resin (OCR). For example, a first substrate SUB1 may be attached to the display panel DP through the transparent adhesive material AD. In an embodiment, the transparent adhesive material AD may be in direct contact with the first substrate SUB1 (e.g., a bottom surface of the first substrate SUB1) and the display panel DP (e.g., a top surface of the display panel DP). For example, the display panel DP and the lens array LSA may be individually manufactured and then attached to each other.

In an embodiment, the lens array LSA may include the first substrate SUB1, a polarizing layer POL, a first buffer layer BFL1, a lower electrode layer LE, an alignment layer ALL, a liquid crystal layer LCL, a lens LS, an upper electrode layer UE, a second buffer layer BFL2, and a second substrate SUB2.

The first substrate SUB1 may be configured to entirely support layers of the lens array LSA. In an embodiment, the first substrate SUB1 may be made of an insulative material such as glass or resin. For example, in an embodiment, the first substrate SUB1 may include a rigid glass substrate. In an embodiment, the first substrate SUB1 may have flexibility. For example, the first substrate SUB1 may include a polyimide (PI) substrate having flexibility. In an embodiment, the first substrate SUB1 may include a substrate formed of another plastic material in addition to the PI substrate. For example, in an embodiment the first substrate SUB1 may include a polycarbonate (PC) substrate or a cyclic olefin polymer (COP) substrate. In an embodiment, the first substrate SUB1 may include a silicon wafer substrate formed using a semiconductor process.

The polarizing layer POL may be disposed on the first substrate SUB1 (e.g., disposed directly thereon in the third direction DR3). The polarizing layer POL may polarize light traveling in the lens array LSA in a predetermined direction. For example, the polarizing layer POL may polarize light incident from the display panel DP in a polarization direction. The polarization direction may be determined according to a form of the polarizing layer POL. For example, the polarizing layer POL may be manufactured to polarize light in a predetermined intended polarizing direction.

In an embodiment, the first substrate SUB1 and the polarizing layer POL may be integrally formed with each other. For example, in an embodiment a layer in which the first substrate SUB1 and the polarizing layer POL are integrally formed may be formed of a plastic film. For example, in an embodiment in which a polarizer is formed directly in the first substrate SUB1, the polarizing layer POL separately disposed on the first substrate SUB1 may be omitted. Hereinafter, for convenience of description, an embodiment in which the first substrate SUB1 and the polarizing layer POL are configured as components separate from each other will be mainly described. However, embodiments of the present disclosure are not necessarily limited thereto.

The first buffer layer BFL1 may be disposed on the polarizing layer POL (e.g., disposed directly thereon in the third direction DR3). The first buffer layer BFL1 may include an inorganic insulating layer including an inorganic material. In an embodiment, the first buffer layer BFL1 may include at least one of silicon nitride (SiNₓ), silicon oxide (SiOₓ), silicon oxynitride (SiOₓN_{y}), and a metal oxide such as aluminum oxide (AlOₓ). The first buffer layer BFL1 may be provided as a single layer or a multi-layer. In an embodiment in which the first buffer layer BFL1 is provided as a multi-layer, layers constituting the multi-layer may be formed of the same material or be formed of different materials from each other. However, embodiments of the present disclosure are no necessarily limited thereto. For example, in some embodiments, the first buffer layer BFL1 may be omitted.

The lower electrode layer LE may be disposed on the first buffer layer BFL1 (e.g., disposed directly thereon in the third direction DR3). The lower electrode layer LE may include a conductive material having light transmissivity (e.g., transparent), such as indium tin oxide (ITO). A ground voltage for forming a potential difference from a voltage applied to the upper electrode layer UE may be applied to the lower electrode layer LE. The voltage may be a reference voltage. The lower electrode layer LE may be referred to as a first electrode layer.

The upper electrode layer UE may be arranged to face the lower electrode layer LE (e.g., in the third direction DR3). The upper electrode layer UE may be disposed on the lens LS (e.g., disposed directly thereon in the third direction DR3). In an embodiment, the upper electrode layer UE may include a conductive material having light transmissivity (e.g., transparent), such as ITO. A driving voltage for controlling a tilting angle of the liquid crystal layer LCL may be applied to the upper electrode layer UE. In an embodiment, a driving voltage for allowing driving of the liquid crystal layer LCL to be on/off may be supplied to the upper electrode layer UE. The term “allowing the driving of the liquid crystal layer LCL to be on” may indicate controlling the liquid crystal layer LCL such that the progress direction of light emitted upwardly (e.g., in the third direction DR3) while passing through the polarizing layer POL is not changed as the light is incident in a minor axis direction of liquid crystal molecules LC. The term “allowing the driving of the liquid crystal layer LCL to be off” may indicate controlling the liquid crystal layer LCL such that light emitted upwardly (e.g., in the third direction DR3) while passing through the polarizing layer POL progresses along a major axis direction of the liquid crystal molecules LC as the light is incident in the major axis direction of the liquid crystal molecules LC. The upper electrode layer UE may be referred to as a second electrode layer.

An electric field may be formed between the upper electrode layer UE and the lower electrode layer LE according to whether the driving voltage is to be applied (or a level of the driving voltage). The alignment direction of the liquid crystal molecules LC included in the liquid crystal layer LCL may be controlled by whether the electric field is to be formed and a magnitude of the electric field.

However, embodiments of the present disclosure are not necessarily limited thereto. In an embodiment, the driving voltage may be supplied to the lower electrode layer LE, and the reference voltage may be supplied to the upper electrode layer UE. Thus, the driving voltage may be supplied to any one of the lower electrode layer LE (e.g., a first electrode layer) and the upper electrode layer UE (e.g., a second electrode layer).

The alignment layer ALL may be disposed on the lower electrode layer LE (e.g., disposed directly thereon in the third direction DR3). In an embodiment, the alignment layer ALL may be rubbing-processed to have a groove (or a predetermined pattern). The liquid crystal molecules LC may be accommodated in the groove of the alignment layer ALL. In an embodiment, the liquid crystal molecules LC may be entirely accommodated in a uniform direction (e.g., a direction parallel to a direction in which the groove extends). For example, the alignment layer ALL may be applied using an inkjet technique. In an embodiment, the alignment layer ALL may be applied on the lower electrode layer LE and then rubbing-processed in a pattern corresponding to the alignment direction. For example, in an embodiment the alignment layer ALL may be rubbing-processed by a rubbing cloth. For example, the alignment layer ALL may be an optical alignment layer, and may be rubbing-processed by irradiating light. However, the method of rubbing-processing the alignment layer ALL is not necessarily limited to the above-described embodiments.

The liquid crystal layer LCL may be disposed on the alignment layer ALL (e.g., disposed directly thereon in the third direction DR3). The liquid crystal layer LCL may be disposed between the lower electrode layer LE and the upper electrode layer UE (e.g., in the third direction DR3). The liquid crystal layer LCL may include the liquid crystal molecules LC of which alignment direction is controlled according to a formed electric field.

The liquid crystal molecules LC may include an optically anisotropic material. For example, the liquid crystal molecules LC may have a major axis refractive index and a minor axis refractive index, which are different from each other. In an embodiment, the major axis refractive index of the liquid crystal molecules LC may be higher than the minor axis refractive index of the liquid crystal molecules LC. However, embodiments of the present disclosure are not necessarily limited thereto.

The liquid crystal layer LCL may include a spacer SPAC. The spacer SPAC may be disposed such that the lens LS is spaced apart from the alignment layer ALL at a certain distance (e.g., in the third direction DR3). Accordingly, a space in which the liquid crystal molecules LC is rotatable can be secured. For example, in an embodiment the spacer SPAC may be entirely disposed in the liquid crystal layer LCL. For example, a plurality of spacers SPAC may be disposed along the liquid crystal layer LCL and may be spaced apart from each other in the first direction DR1.

The lens LS may be disposed on the liquid crystal layer LCL (e.g., disposed directly thereon in the third direction DR3). Referring to FIG. 3, lenses LS may be adjacent to each other in the first direction DR1, thereby constituting a lens array.

The lens LS may include an optically isotropic polymer. For example, the lens LS may include an optically isotropic material having a refractive index substantially equal to the major axis refractive index or the minor axis refractive index of the liquid crystal molecules LC. For example, in an embodiment the isotropic polymer may include a photocurable resin such as acrylic resin or epoxy resin, or include a thermosetting resin. For example, in an embodiment the photocurable resin may be cured by ultraviolet (UV) having a wavelength in a band of about 10 nm (nanometers) to about 400 nm.

Light polarized in a predetermined direction while passing through the polarizing layer POL may be incident onto the liquid crystal layer LCL. The direction in which light incident on to the lens LS progresses may vary according to a state of the liquid crystal molecules LC. For example, when light passes through the lens LS in a state in which the driving of the liquid crystal layer LCL is off, the light may progress without being refracted in the lens LS. On the contrary, when light passes through the lens LS in a state in which the driving of the liquid crystal layer LCL is on, the light may be refracted to progress while being refracted in the lens LS.

The second buffer layer BFL2 may be disposed on the upper electrode layer UE (e.g., disposed directly thereon in the third direction DR3). The second buffer layer BFL2 may include an inorganic insulating layer including an inorganic material. In an embodiment, the second buffer layer BFL2 may include at least one of silicon nitride (SiNₓ), silicon oxide (SiOₓ), silicon oxynitride (SiOₓN_{y}), and a metal oxide such as aluminum oxide (AlOₓ). The second buffer layer BFL2 may be provided as a single layer or a multi-layer. In an embodiment in which the second buffer layer BFL2 is provided as the multi-layer, layers constituting the multi-layer may be formed of the same material or be formed of different materials from each other. However, embodiments of the present disclosure are not necessarily limited thereto. For example, in some embodiments, the second buffer layer BFL2 may be omitted.

The second substrate SUB2 may be disposed on the second buffer layer BFL2 (e.g., disposed directly thereon in the third direction DR3). However, embodiments of the present disclosure are not necessarily limited thereto and the second substrate SUB2 may be disposed directly on the upper electrode layer UE in some embodiments. The second substrate SUB2 may be made of an insulative material such as glass or resin. In an embodiment, the second substrate SUB2 may include a glass substrate. In an embodiment, the second substrate SUB2 may include a polyimide (PI) substrate. In an embodiment, the second substrate SUB2 may include a substrate formed of another plastic material in addition to the PI substrate. For example, in an embodiment the second substrate SUB2 may include a PC substrate or a COP substrate. In an embodiment, the second substrate SUB2 may include a silicon wafer substrate formed using a semiconductor process.

For example, the second substrate SUB2 may serve as a substrate (e.g., a mother substrate) for forming/manufacturing the lens LS. Also, the second substrate SUB2 may protect the lens LS from external pollution, impact, scratches, and the like.

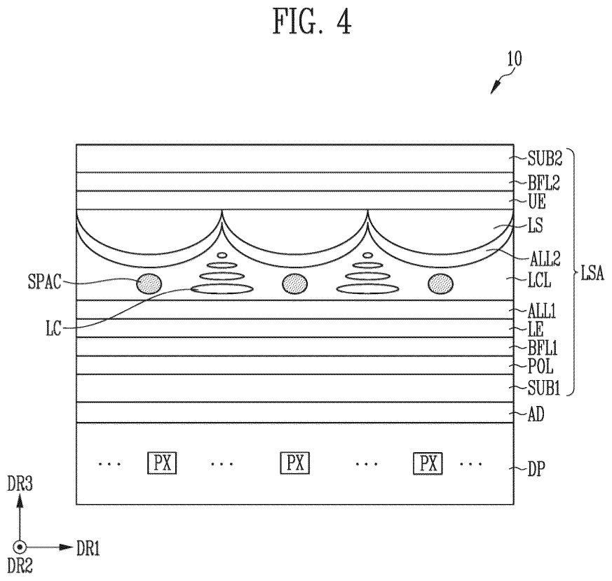

FIG. 4 is a cross-sectional view illustrating an embodiment of the display device 10 shown in FIG. 2.

The display device 10 in accordance with an embodiment shown in FIG. 4 may further include a second alignment layer ALL2, as compared with the display device 10 in accordance with an embodiment shown in FIG. 3 which only includes the alignment layer ALL.

The second alignment layer ALL2 may be disposed between the liquid crystal layer LCL and the lens LS (e.g., in the third direction DR3). In an embodiment, the second alignment layer ALL2 may be rubbing-processed. For example, the second alignment layer ALL2 may be applied using an inkjet technique. In an embodiment, the second alignment layer ALL2 may be applied on the lower electrode layer LE (e.g., in the third direction DR3) and then rubbing-processed in a pattern corresponding to the alignment direction. For example, in an embodiment the second alignment layer ALL2 may be rubbing-processed by a rubbing cloth. For example, in an embodiment the second alignment layer ALL2 may be an optical alignment layer, and be rubbing-processed by irradiating light. However, the method of rubbing-processing the second alignment layer ALL2 is not necessarily limited to the above-described embodiments. For example, in an embodiment, the second alignment layer ALL2 may be formed directly in the lens LS and an alignment agent is not applied but rubbing-processed in the lens LS.

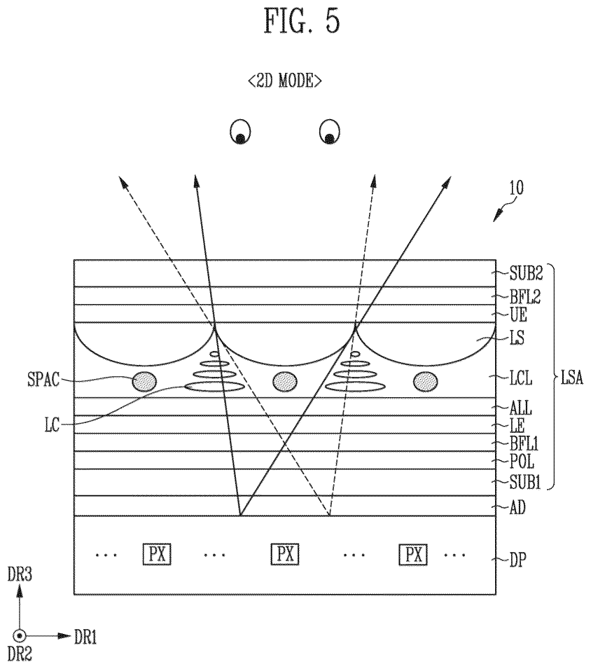

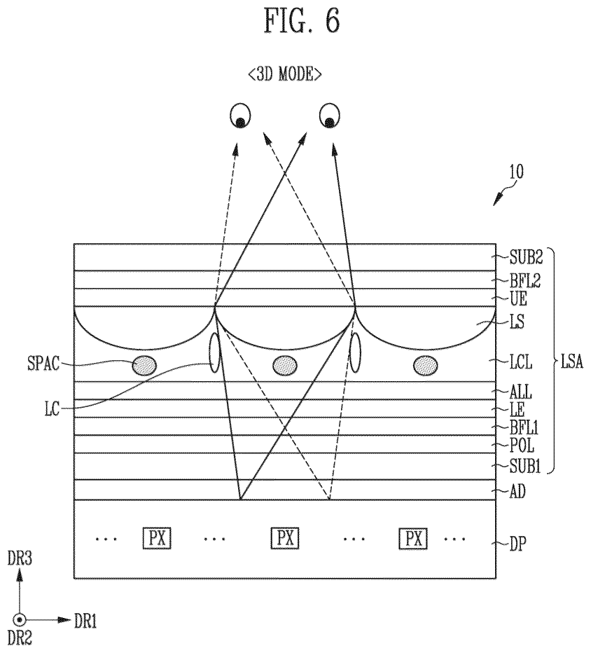

FIG. 5 is a cross-sectional view illustrating an example in which the display device 10 shown in FIG. 3 operates in a first mode. FIG. 6 is a cross-sectional view illustrating an example in which the display device 10 shown in FIG. 3 operates in a second mode.

Referring to FIG. 5, in a 2D image mode (e.g., a first mode), no electric field may be formed between the lower electrode layer LE and the upper electrode layer UE. For example, in the first mode, a driving voltage may not be applied to the upper electrode layer UE. Alternatively, in the first mode, the same voltage may be applied to the upper electrode layer UE and the lower electrode layer LE.

When no electric field is formed between the upper electrode layer UE and the lower electrode layer LE, a refractive index of the lens LS is substantially equal to a refractive index of the liquid crystal layer LCL. Accordingly, light passing through the liquid crystal layer LCL is not refracted while passing through the lens LS (e.g., light progresses straight), and the display device 10 generates the same image to both eyes of a user, thereby displaying a 2D image.

Referring to FIG. 6, in a stereoscopic image mode (e.g., a second mode), a driving voltage may be applied to the upper electrode layer UE, and an electric field may be formed between the upper electrode layer UE and the lower electrode layer LE.

When the electric field is formed between the upper electrode layer UE and the lower electrode layer LE, a refractive index of the lens LS is higher than a refractive index of the liquid crystal layer LCL. Accordingly, light passing through the liquid crystal layer LCL may be refracted while passing through the lens LS, and accordingly, the lens LS may substantially serve as a convex lens. The light refracted in the lens LS may be divided into a progress path of light corresponding to a right-eye image and a progress path of light corresponding to a left-eye image, and the lights may converge on different focuses (e.g., focal areas), thereby implementing a stereoscopic image. For example, in the second mode, the lens LS may refract light incident onto the lens LS, thereby forming a light field.

The lens array LSA in accordance with an embodiment of the present disclosure may include a polarizing layer POL therein. In accordance with an embodiment of the present disclosure, the lens array LSA along with the display panel DP not separately including a polarizing layer can constitute a stereoscopic image display device. Accordingly, an error between the direction which light is polarized by the polarizing layer POL and the direction in which the liquid crystal molecules LC are aligned is considerably reduced (e.g., minimized), so that image quality characteristics of stereoscopic images can be increased.

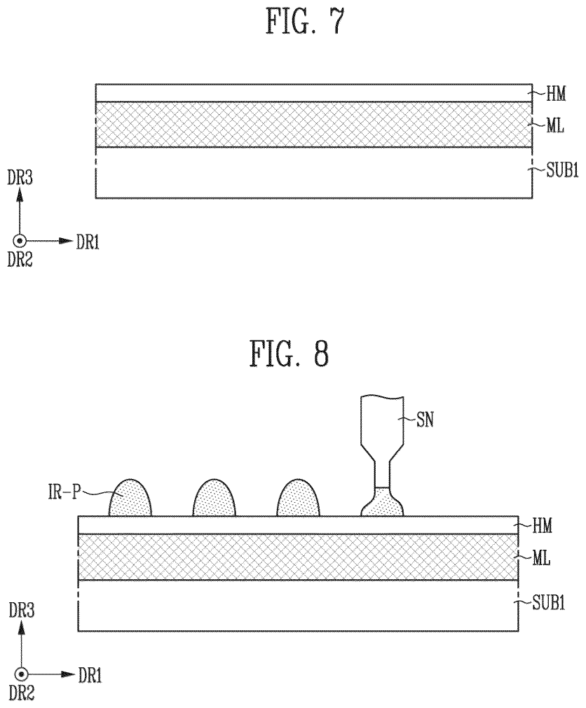

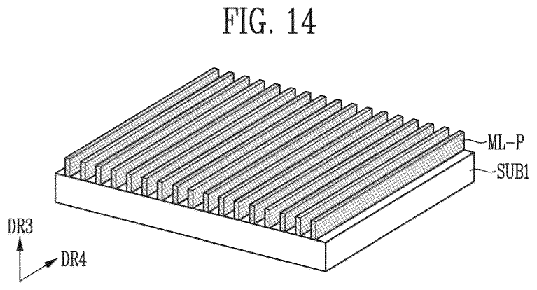

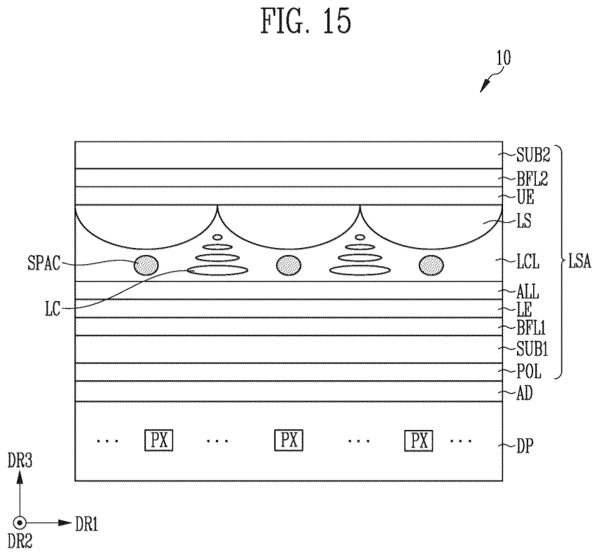

FIGS. 7 to 13 are views illustrating an example in which a polarizing layer POL shown in FIG. 3 is formed. FIG. 14 is a view illustrating an embodiment of an arrangement of optical patterns ML-P shown in FIG. 13.

Referring to FIGS. 7 to 13, in an embodiment the polarizing layer POL may be a wire grid polarizer. In an embodiment, the polarizing layer POL may be formed through an imprinting process. For example, the polarizing layer POL may include optical patterns ML-P and a passivation layer PSV covering the optical patterns ML-P.

An embodiment in which the polarizing layer POL is formed in the form of a wire grid polarizer through an imprinting process is exemplified with reference to FIGS. 7 to 13. However, the formation method and form of the polarizing layer POL in accordance with the embodiments of the present disclosure are not necessarily limited thereto.

Referring to FIG. 7, a metal layer ML and a hard mask HM may be formed on the first substrate SUB1 (e.g., formed directly thereon in the third direction DR3). For example, the metal layer ML may include aluminum (Al), but embodiments of the present disclosure are not necessarily limited thereto. For example, the hard mask HM may include an inorganic insulating layer including an inorganic material. In an embodiment, the hard mask HM may include at least one of silicon nitride (SiNₓ), silicon oxide (SiOₓ), silicon oxynitride (SiOₓN_{y}), and a metal oxide such as aluminum oxide (AlOₓ). However, embodiments of the present disclosure are not necessarily limited thereto.

In an embodiment, an adhesion promoter may be provided on (e.g., disposed directly thereon) the hard mask HM. The adhesion promoter may help a pattern forming resin IR-P (see FIG. 8) be coupled on the hard mask HM.

Referring to FIG. 8, the pattern forming resin IR-P may be provided on the hard mask HM (e.g., disposed directly thereon in the third direction DR3). In an embodiment, the pattern forming resin IR-P may be provided through a resin supplier SN. In an embodiment, the resin supplier SN may include a nozzle configured to apply a certain amount (e.g., a predetermined amount) of the pattern forming resin IR-P to an area in which pattern formation is required to manufacture an optical member. However, embodiments of the present disclosure are not necessarily limited thereto, and the pattern forming resin IR-P may be provided using various coating methods. For example, in an embodiment the pattern forming resin IR-P may be a photoresist. Any one of a positive photoresist and a negative photoresist may be used as the photoresist.

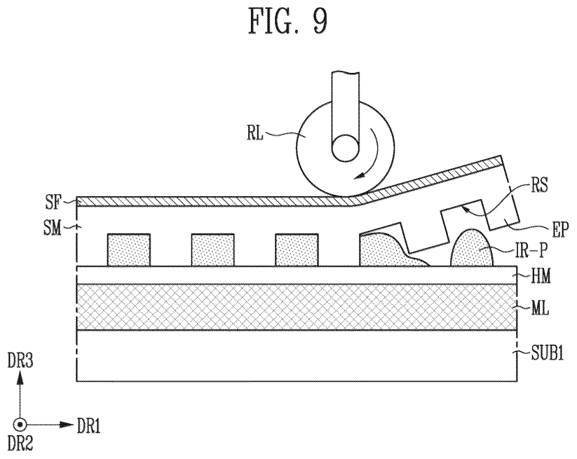

Referring to FIG. 9, a soft mold SM may be provided over (e.g., directly over) the pattern forming resin IR-P. The pattern forming resin IR-P applied on the first substrate SUB1 may be filled in a recess RS of the soft mold SM. In an embodiment, a pressurizing roller RL may be disposed on the soft mold SM to allow the soft mold SM to be disposed on the first substrate SUB1 having the metal layer ML while moving.

A base film SF may be further provided on the soft mold SM (e.g., disposed directly thereon in the third direction DR3). The base film SF may include polymer resin. In an embodiment, the base film SF may be implemented as a transparent polymer film. For example, in an embodiment the base film SF may include polyethylene terephthalate. In another example, the base film SF may include polycarbonate. The base film SF may serve as a supporter which supports the soft mold SM.

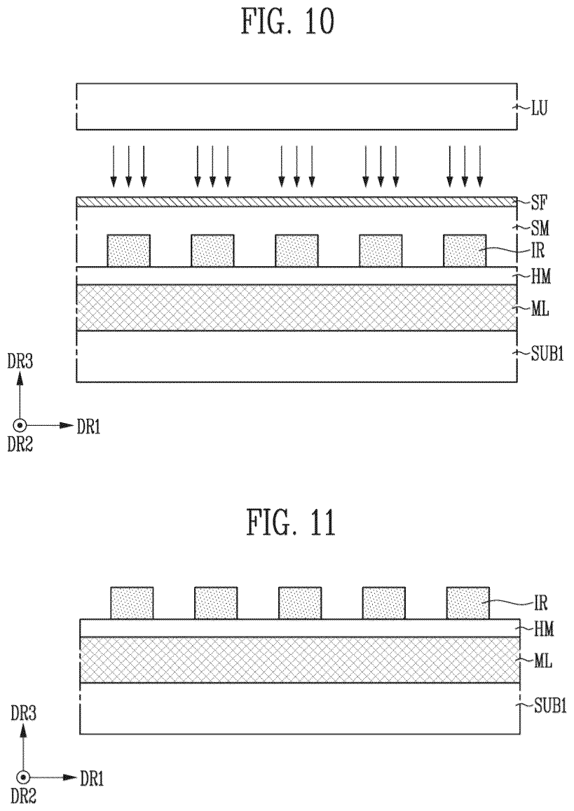

Referring to FIGS. 9 and 10, the pattern forming resin IR-P may be photocured. An external light source LU may be located above the soft mold SM. In an embodiment, the external light source LU may provide ultraviolet which cures the pattern forming resin IR-P while being transmitted through the soft mold SM, thereby forming an arbitrary pattern IR. The arbitrary pattern IR obtained by photocuring the pattern forming resin IR-P may be formed to be fixed on the metal layer ML. The arbitrary pattern IR may be a pattern having a size corresponding to the recess RS of the soft mold SM. Thus, in an embodiment the arbitrary pattern may have a size and shape reflective of the recess RS of the soft mold SM.

Referring to FIGS. 10 and 11, the soft mold SM may be removed after the arbitrary pattern IR is formed.

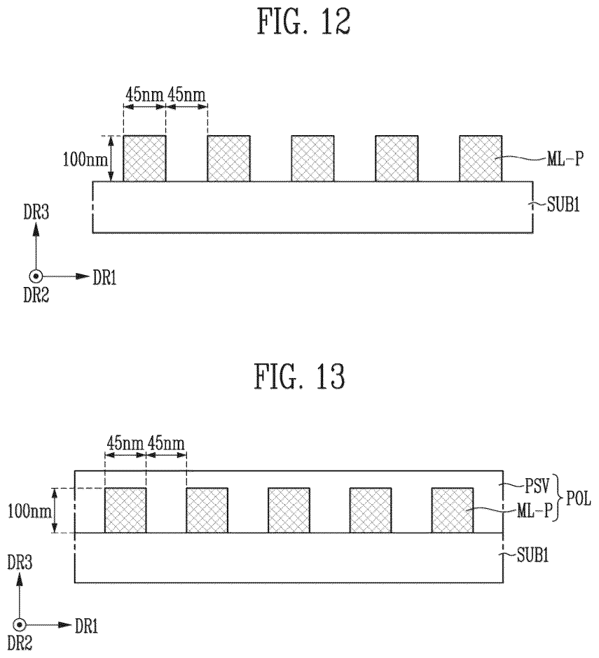

Referring to FIGS. 11 and 12, in an embodiment optical patterns ML-P may be formed by etching the metal layer ML. Each optical pattern ML-P may be formed at a position corresponding to the arbitrary pattern IR. For example, after the soft mold SM (see FIG. 10) is removed, components on the first substrate SUB1 may be entirely etched. For example, in an embodiment the arbitrary pattern IR, the hard mask HM, and a portion of the metal layer ML may be removed through a dry etch process.

For example, in an embodiment a width of the optical pattern ML-P may be about 45 nm. For example, a distance between immediately adjacent optical patterns ML-P of the optical patterns ML-P may be about 45 nm. For example, in an embodiment a height (e.g., length in the third direction DR3) of the optical pattern ML-P may be about 100 nm. However, the width of the optical pattern ML-P, the distance between the optical patterns ML-P, and the height of the optical pattern ML-P are not necessarily limited to the above-described embodiments.

Referring to FIG. 13, a passivation layer PSV may be formed to cover the optical patterns ML-P. For example, the passivation layer PSV may protect components disposed thereunder, and provide a flat top surface. For example, the passivation layer PSV may include an inorganic insulating layer including an inorganic material and/or an organic insulating layer including an organic material. In an embodiment, the inorganic insulating layer may include at least one of silicon oxide (SiOₓ), silicon nitride (SiNₓ), silicon oxynitride (SiOₓN_{y}), and a metal oxide such as aluminum oxide (AlOₓ). In an embodiment, the organic insulating layer may include, for example, at least one of acrylic resin, epoxy resin, phenolic resin, polyamide resin, polyimide resin, unsaturated polyester resin, polyphenylene ether resin, polyphenylene sulfide resin, and benzocyclobutene resin. However, embodiments of the present disclosure are not necessarily limited thereto.

Referring to FIG. 14, the optical pattern ML-P may have a stripe shape extending longitudinally in a fourth direction DR4. In an embodiment, the fourth direction DR4 may be a direction perpendicular to the third direction DR3. In an embodiment, the fourth direction DR4 may be identical to any one of the first direction DR1 and the second direction DR2, which are described above. However, in some embodiments, the fourth direction DR4 may be intersect the first direction DR1 and the second direction DR2. When light is incident from the display panel DP (see FIG. 3), the light progresses while vibrating in horizontal and vertical directions with respect to a progress direction because of general characteristics thereof. Hence, only light incident parallel to a spaced between the optical patterns ML-P (e.g., light progressing in the fourth direction DR4) may pass through the optical pattern ML-P. Accordingly, the optical pattern ML-P may serve as a polarizing layer.

FIG. 15 is a cross-sectional view illustrating a display device 10 in accordance with an embodiment of the present disclosure.

A lens array LSA in accordance with an embodiment of the present disclosure is configured substantially identically to the lens array LSA of the display device 10 shown in FIG. 3, except for a position of the polarizing layer POL. In FIG. 15, identical or similar components are designated by like reference numerals, and overlapping descriptions may be omitted for economy of description.

Referring to FIG. 15, the polarizing layer POL may be disposed under the first substrate SUB1 (e.g., directly thereunder in a direction opposite to the third direction DR3). In an embodiment, the polarizing layer POL may be attached to the first substrate SUB1 under the first substrate SUB1. In this embodiment, the transparent adhesive material AD may be in direct contact with the polarizing layer POL (e.g., a bottom surface of the polarizing layer POL) and the display panel DP (e.g., an upper surface of the display panel DP). However, embodiments of the present disclosure are not necessarily limited thereto. For example, in an embodiment, the polarizing layer POL may be formed under the first substrate SUB1 through an imprinting process.

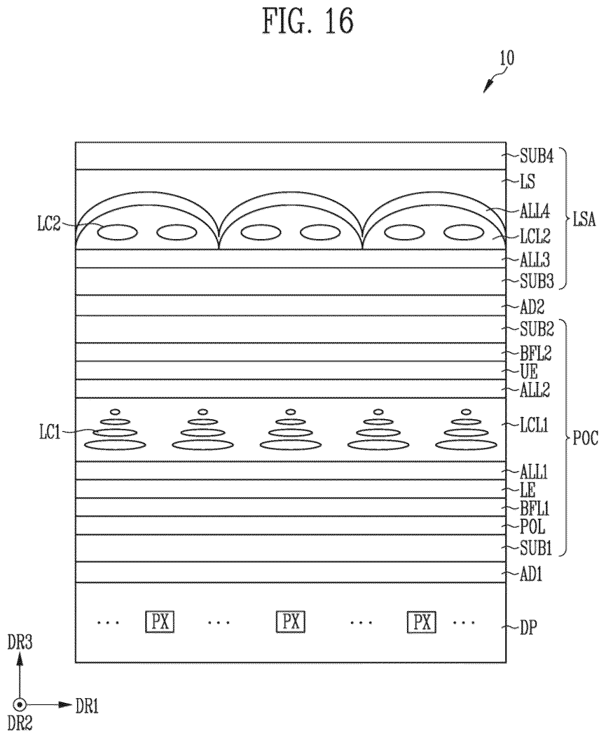

FIG. 16 is a cross-sectional view illustrating a display device 10 in accordance with an embodiment of the present disclosure.

Referring to FIG. 16, in an embodiment the display device 10 may include a display panel DP, a polarization conversion unit POC, and a lens array LSA.

The polarization conversion unit POC may be disposed on the display panel DP (e.g., in the third direction DR3). In an embodiment, the polarization conversion unit POC may be attached to the display panel DP through a first transparent adhesive material AD1. For example, a first substrate SUB1 may be attached to the display panel DP through the first transparent adhesive material AD1. For example, the display panel DP and the polarization conversion unit POC may be individually manufactured and then attached to each other.

In an embodiment, the polarization conversion unit POC may include the first substrate SUB1, a polarizing layer POL, a first buffer layer BFL1, a lower electrode layer LE, a first alignment layer ALL1, a first liquid layer LCL1, a second alignment layer ALL2, an upper electrode layer UE, a second buffer layer BFL2, a second substrate SUB2, and the like.

Referring to FIG. 16, the polarizing layer POL may be disposed on the first substrate SUB1 (e.g., disposed directly thereon in the third direction DR3). However, embodiments of the present disclosure are not necessarily limited thereto, and the polarizing layer POL may be disposed under (e.g., disposed directly thereon in a direction opposite to the third direction DR3) the first substrate SUB1 as shown in FIG. 15 in some embodiments.

The first buffer layer BFL1 may be disposed on the polarizing layer POL (e.g., disposed directly thereon in the third direction DR3). The first buffer layer BFL1 may include an inorganic insulating layer including an inorganic material. For example, in an embodiment, the first buffer layer BFL1 may include at least one of silicon nitride (SiNₓ), silicon oxide (SiOₓ), silicon oxynitride (SiOₓN_{y}), and a metal oxide such as aluminum oxide (AlOₓ). The first buffer layer BFL1 may be provided as a single layer or a multi-layer. In an embodiment in which the first buffer layer BFL1 is provided as a multi-layer, layers constituting the multi-layer may be formed of the same material or be formed of different materials. In some embodiments, the first buffer layer BFL1 may be omitted.

The lower electrode layer LE may be disposed on the first buffer layer BFL1 (e.g., disposed directly thereon in the third direction DR3). The lower electrode layer LE may include a conductive material having light transmissivity (e.g., transparent), such as ITO. A ground voltage for forming a potential difference from a voltage applied to the upper electrode layer UE may be applied to the lower electrode layer LE. However, embodiments of the present disclosure are not necessarily limited thereto, and a driving voltage may be applied to the lower electrode layer LE.

The first alignment layer ALL1 may be disposed on the lower electrode layer LE (e.g., disposed directly thereon in the third direction DR3). In an embodiment, the first alignment layer ALL1 may be rubbing-processed to align first liquid crystal molecules LC1 of the first liquid crystal layer LCL1 in a predetermined direction.

The first liquid crystal layer LCL1 may be disposed on the first alignment layer ALL1 (e.g., disposed directly thereon in the third direction DR3). The first liquid crystal layer LCL1 may include the first liquid crystal molecules LC1. The first liquid crystal molecules LC1 may have optical anisotropy in which a major axis refractive index and a minor axis refractive index are different from each other. In an embodiment, the first liquid crystal molecules LC1 may be, for example, Twisted Nematic (TN) liquid crystals.

The second alignment layer ALL2 may be disposed on the first liquid crystal layer LCL1 (e.g., disposed directly thereon in the third direction DR3). In an embodiment, the second alignment layer ALL2 may be rubbing-processed to align the first liquid crystal molecules LC1 of the first liquid crystal layer LCL1 in a predetermined direction. However, embodiments of the present disclosure are not necessarily limited thereto.

The upper electrode layer UE may be disposed on the second alignment layer ALL2 (e.g., disposed directly thereon in the third direction DR3). The upper electrode layer UE may include a conductive material having light transmissivity (e.g., transparent), such as ITO. A driving voltage for driving the first liquid crystal layer LCL1 may be applied to the upper electrode layer UE. However, embodiments of the present disclosure are not necessarily limited thereto, and a reference voltage may be applied to the upper electrode layer UE and a driving voltage may be applied to the lower electrode layer LE in some embodiments.

The second buffer layer BFL2 may be disposed on the upper electrode layer UE (e.g., disposed directly thereon in the third direction DR3). The second buffer layer BFL2 may include an inorganic insulating layer including an inorganic material. In an embodiment, the second buffer layer BFL2 may include at least one of silicon nitride (SiNₓ), silicon oxide (SiOₓ), silicon oxynitride (SiOₓN_{y}), and a metal oxide such as aluminum oxide (AlOₓ). The second buffer layer BFL2 may be provided as a single layer or a multi-layer. In an embodiment in which the second buffer layer BFL2 is provided as a multi-layer, layers constituting the multi-layer may be formed of the same material or be formed of different materials. In some embodiments, the second buffer layer BFL2 may be omitted.

The second substrate SUB2 may be disposed on (e.g., disposed directly thereon in the third direction DR3) the second buffer layer BFL2 (or the upper electrode layer UE).

The lens array LSA may be disposed on the polarization conversion unit POC (e.g., in the third direction DR3). In an embodiment, the lens array LSA may be attached on the polarization conversion unit POC through a second transparent adhesive material AD2. For example, the second substrate SUB2 may be attached to the lens array LSA through the second transparent adhesive material AD2. For example, the polarization conversion unit POC and the lens array LSA may be individually manufactured and then attached to each other.

In an embodiment, the lens array LSA may include a third substrate SUB3, a third alignment layer ALL3, a second liquid crystal layer LCL2, a fourth alignment layer ALL4, a lens LS, a fourth substrate SUB4, and the like. In some embodiments, the lens array LSA may further include at least one buffer layer.

The third alignment layer ALL3 may be disposed on the third substrate SUB3 (e.g., disposed directly thereon in the third direction DR3). In an embodiment, the third alignment layer ALL3 may be rubbing-processed to align second liquid crystal molecules LC2 of the second liquid crystal layer LCL2 in a predetermined direction. However, embodiments of the present disclosure are not necessarily limited thereto.

The second liquid crystal layer LCL2 may be disposed on the third alignment layer ALL3 (e.g., disposed directly thereon in the third direction DR3). The second liquid crystal layer LCL2 may include the second liquid crystal molecules LC2. The second liquid crystal molecules LC2 may have an optical anisotropy in which a major axis refractive index and a minor axis refractive index are different from each other. In an embodiment, a difference between the major axis refractive index and the minor axis refractive index of the second liquid crystal molecules LC2 may be greater than a difference between the major axis refractive index and the minor axis refractive index of the first liquid crystal molecules LC1. Accordingly, a three-dimensional image can be more effectively provided to a user.

The fourth alignment layer ALL4 may be located on the second liquid layer LCL2 (e.g., disposed directly thereon in the third direction DR3). In an embodiment, the fourth alignment layer ALL4 may be rubbing-processed to align the second liquid crystal molecules LC2 of the second liquid crystal layer LCL2 in a predetermined direction. However, embodiments of the present disclosure are not necessarily limited thereto.

The lens LS may be located on the fourth alignment layer ALL4 (e.g., disposed directly thereon in the third direction DR3).

Referring to FIG. 16, the lens LS may have an upwardly convex shape.

In an embodiment, the lens LS may include an optically isotropic polymer. In the embodiment shown in FIG. 6, a refractive index of the lens LS may be configured lower than a refractive index of the second liquid crystal layer LCL2.

In an embodiment, light incident in a minor axis direction of the second liquid crystal molecules LC2 is not refracted while passing through the lens LS but may progress. Accordingly, a two-dimensional image may be displayed in a first mode. In a second mode, light incident in a major axis direction of the second liquid crystal molecules LC2 may be refracted as if the light passes through a medium having a refractive index lower than the refractive index of the lens LS while passing through the lens LS. Accordingly, the second liquid crystal layer LCL2 may selectively serve as a convex lens.

The fourth substrate SUB4 may be disposed on the lens LS (e.g., disposed directly thereon in the third direction DR3). Light passing through the lens LS may be emitted to an area on the fourth substrate SUB4 to provide a two-dimensional image or a three-dimensional image to the user.

In an embodiment, the second liquid crystal layer LCL2 may include a reactive mesogen. The second liquid crystal layer LCL2 may have a mesogen structure, thereby having the shape of a convex lens. The second liquid crystal layer LCL2 may be cured by reacting with light (e.g., ultraviolet) to be fixed to have a predetermined liquid crystal phase. Accordingly, the second liquid crystal layer LCL2 may have an optically anisotropic fixed phase therein.

Referring to FIG. 16, a tilting angle of the first liquid crystal molecules LC1 may be controlled according to a potential difference between the lower electrode layer LE and the upper electrode layer UE.

For example, when there is no potential difference between the lower electrode layer LE and the upper electrode layer UE, light polarized in the polarizing layer POL may be polarized in a minor axis direction of the first liquid crystal molecules LC1, to be incident in the minor axis direction of the second liquid crystal molecules LC2. Accordingly, a two-dimensional image may be displayed in a first mode.

For example, when there is a potential difference between the lower electrode layer LE and the upper electrode layer UE exists, light polarized in the polarizing layer POL may be incident in the major axis direction of the second liquid crystal molecules LC2 while passing through a major axis direction of the first liquid crystal molecules LC1. Accordingly, a three-dimensional image may be displayed in a second mode.

Embodiments of the present disclosure can be applied to display devices and electronic devices including the same. For example, embodiments of the present disclosure can be applied to digital TVs, 3D TVs, mobile phones, smart phones, tablet computers, VR devices, PCs, home appliances, notebook computers, PDAS, PMPs, digital cameras, music players, portable game consoles, navigation systems, and the like. However, embodiments of the present disclosure are not necessarily limited thereto and the electronic device that the display device may be applied to may be various different small-sized, medium-sized or large-sized electronic devices.

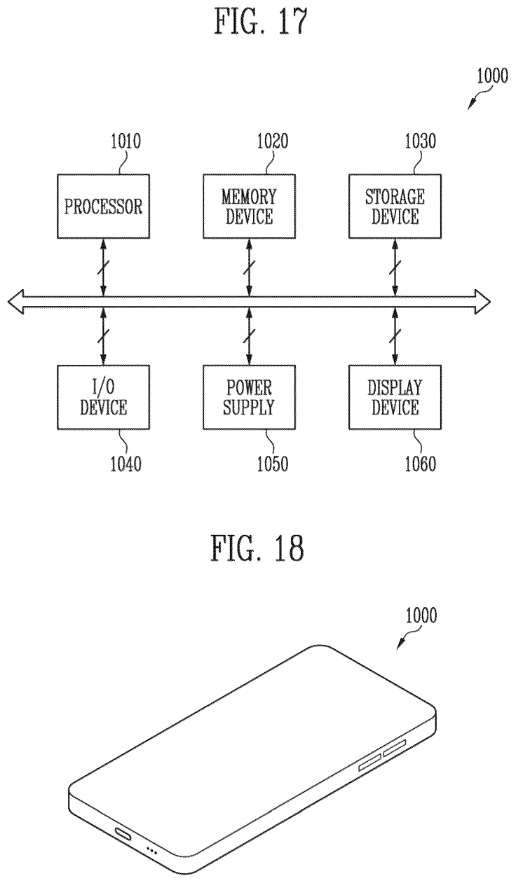

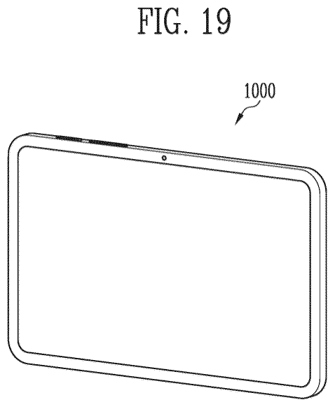

FIG. 17 is a schematic block diagram illustrating an electronic device 1000 including a display device in accordance with an embodiment. FIG. 18 is a schematic diagram illustrating an embodiment in which the electronic device 1000 of FIG. 17 is a smartphone. FIG. 19 is a schematic diagram illustrating an embodiment in which the electronic device 1000 of FIG. 17 is a tablet computer.

Referring to FIGS. 17 to 19, in an embodiment the electronic device 1000 may include a processor 1010, a memory device 1020, a storage device 1030, an input/output (I/O) device 1040, a power supply 1050, and a display device 1060. The display device 1060 may be the display device 10 of FIG. 2. The electronic device 1000 may further include various ports for communication with a video card, a sound card, a memory card, a USB device, or other systems. In an embodiment, as illustrated in FIG. 18, the electronic device 1000 may be a smartphone. In an embodiment, as illustrated in FIG. 19, the electronic device 1000 may be a tablet computer. However, the aforementioned examples are illustrative, and the electronic device 1000 is not necessarily limited to the aforementioned examples. For example, in some embodiments the electronic device 1000 may be a cellular phone, a video phone, a smart pad, a smartwatch, a navigation device for vehicles, a computer monitor, a laptop computer, a head-mounted display device, or the like.

The processor 1010 may perform specific calculations or tasks. In an embodiment, the processor 1010 may be a microprocessor, a central processing unit, an application processor, or the like. The processor 1010 may be connected to other components through an address bus, a control bus, a data bus, and the like. In an embodiment, the processor 1010 may be connected to an expansion bus such as a peripheral component interconnect (PCI) bus. In an embodiment, the processor 1010 may provide input image data to the display device 1060. Hence, the display device 1060 may display an image based on the input image data provided from the processor 1010.

The memory device 1020 may store data needed to perform the operation of the electronic device 1000. The memory device 1020 may function as a working memory and/or a buffer memory for the processor 1010. For example, in an embodiment the memory device 1020 may include one or more volatile memory devices such as a dynamic random access memory (DRAM) device, a static random access memory (SRAM) device, and a mobile DRAM device.

The storage device 1030 may store data in response to control signals or data from the processor 1010. In an embodiment, the storage device 1030 may include one or more non-volatile storages to retain the data even when the electronic device 1000 is powered off. In some embodiments, the storage device 1030 may include a solid state drive (SSD), a hard disk drive (HDD), a CD-ROM, or the like.

The I/O device 1040 may include input devices such as a keyboard, a keypad, a touchpad, a touch screen, and a mouse, and output devices such as a speaker and a printer. In an embodiment, the display device 1060 may be integrated with the I/O device 1040.

The power supply 1050 may supply power needed to perform the operation of the electronic device 1000. For example, the power supply 1050 may include a power management integrated circuit (PMIC). In an embodiment, the power supply 1050 may supply power to the display device 1060.

The display device 1060 may display images in response to control signals or data from the processor 1010. The display device 1060 may be connected to other components through the buses or other communication links.

In an embodiment of the present disclosure, the lens array includes a polarizing layer, so that a stereoscopic image can be displayed as the lens array is coupled to the display panel that does not include a polarizing layer.

In an embodiment of the present disclosure, the lens array includes a polarizing layer, so that a polarization direction of the polarizing layer can be determined by considering a direction of the lens array, unlike an embodiment in which the polarizing layer is included in the display panel. Accordingly, image quality characteristics of stereoscopic images can be increased.

Non-limiting embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made to the described embodiments without departing from the spirit and scope of the present disclosure.

What is claimed is:

1. A lens array comprising:
a polarizing layer polarizing light traveling in the lens array;
a first electrode layer disposed on the polarizing layer;
a lens layer disposed on the first electrode layer; and
a second electrode layer disposed on the lens layer and facing the first electrode layer.

2. The lens array of claim 1, wherein the polarizing layer is formed through an imprinting process.

3. The lens array of claim 1, wherein the polarizing layer is a wire grid polarizer.

4. The lens array of claim 1, wherein the polarizing layer includes:
an optical pattern; and
a passivation layer covering the optical pattern.

5. The lens array of claim 4, wherein the optical pattern includes a metal.

6. The lens array of claim 4, wherein the optical pattern has a stripe shape.

7. The lens array of claim 1, further comprising a liquid crystal layer disposed between the first electrode layer and the lens layer.

8. The lens array of claim 7, wherein the lens layer includes an optically isotropic polymer.

9. The lens array of claim 8, wherein the polarizing layer polarizes the light in a polarization direction, and
wherein, when an electric field is formed between the first electrode layer and the second electrode layer, a refractive index of the lens layer is higher than a refractive index of the liquid crystal layer with respect to the polarization direction.

10. The lens array of claim 8, wherein the polarizing layer polarizes the light in a polarization direction, and
wherein, when there is no electric field formed between the first electrode layer and the second electrode layer, a refractive index of the lens layer is substantially equal to a refractive index of the lens layer with respect to the polarization direction.

11. The lens array of claim 1, further comprising a first substrate, wherein the polarizing layer is disposed above the first substrate.

12. The lens array of claim 1, further comprising a first substrate,
wherein the polarizing layer is disposed under the first substrate, and
wherein the first electrode layer is disposed above the first substrate.

13. The lens array of claim 1, further comprising:
a first substrate; and
a second substrate,
wherein the lens layer is disposed between the first substrate and the second substrate.

14. A display device comprising:
a display panel including a pixel, the display panel does not include a polarizing layer;
a polarization conversion unit disposed on the display panel; and
a lens array disposed on the polarization conversion unit,
wherein the polarization conversion unit comprises:
a polarizing layer polarizing light incident from the display panel in a polarization direction; and
a liquid crystal layer disposed on the polarizing layer.

15. An electronic device comprising:
a processor providing input image data;
a display panel including pixels displaying an image corresponding to the input image data; and
a lens array disposed on the display panel,
wherein the lens array comprises:
a polarizing layer polarizing light incident from the display panel; and
a lens layer disposed on the polarizing layer.
